(19) United States
(12) Patent Application Publication
(10) Pub. No.: US 2021/0252785 A1
(43) Pub. Date: Aug. 19, 2021

(54) CALIBRATING CAMERAS IN THREE-DIMENSIONAL PRINTER DEVICES

(71) Applicant: HEWLETT-PACKARD DEVELOPMENT COMPANY, L.P., Spring, TX (US)

(72) Inventors: Luis GARCIA GARCIA, Sant Cugat del Valles (ES); Marina FERRAN FARRES, Vancouver, WA (US); Alejandro Manuel DE PENA HEMPEL, Sant Cugat del Valles (ES)

(21) Appl. No.: 16/973,158

(22) PCT Filed: Nov. 22, 2018
(86) PCT No.: PCT/US2018/062367

§ 371 Date: Dec. 8, 2020

(51) Int. Cl. B29C 64/295; B29C 64/153; G06T 7/80; B29C 64/393; G06T 7/70

(52) U.S. Cl. CPC B29C 64/295; B29C 64/153; G06T 2207/10048; B29C 64/393; G06T 7/70; G06T 7/80

(57) ABSTRACT

An example device includes a camera to aim towards a build platform to receive material to be fused to form an article. The camera is to capture thermal images including a correction image captured during formation of the article at the build platform. The correction image is to be referenced to adjust a parameter of the formation of the article at the build platform. The example device further includes a controller connected to the camera. The controller is to control the camera to capture a calibration image with a heater associated with the build platform turned on. The controller is further to use the calibration image to compute a calibration to apply to the correction image.

### BACKGROUND

Three-dimensional (3D) printing and similar types of material additive manufacturing may be used to create diverse objects, such as prototype objects and production objects.

A three-dimensional printing system may fuse material, such as powder, to form a printed article. In powder-bed material fusion printing systems, layers of powder are progressively introduced and select portions of each layer are fused with the previous layer. Material fusion may be performed using an energy source, a light source, laser, electron beam, a chemical fusing agent, binding agent, curing agent, an energy absorbing fusing agent, or combination of such that may be jetted or sprayed (e.g., via a thermal or piezo inkjet-type printhead), or similar. Fused layers thereby form a printed article and unfused material may be recovered and recycled.

### BRIEF DESCRIPTION OF THE DRAWINGS

FIG. 1 is a schematic diagram of an example device that uses a heater to calibrate formation of an article at a build platform of a three-dimensional printer.

FIG. 2 is a schematic diagram of the example device of FIG. 1 with the build platform moved down.

FIG. 3 is a schematic diagram of expected and actual representations of an example calibration heater.

FIG. 4 is a flowchart of an example method to calibrate formation of an article at a build platform of a three-dimensional printer using a heater.

FIG. 5 is a schematic diagram of an example workflow that uses a calibration thermal image of a heater to calibrate thermal images used to control a three-dimensional printing process.

FIG. 6 is a flowchart of an example method to compute a calibration based on a representation of a heater associated with a build platform.

FIG. 7A is an example calibration thermal image of a heater associated with a build platform of a three-dimensional printer.

FIG. 7B is the example calibration thermal image of FIG. 7A after thresholding is performed.

FIG. 7C is the example thresholded calibration thermal image of FIG. 7B after edge detection is performed.

FIG. 7D is the example edge-detected calibration thermal image of FIG. 7C after edge extrapolation is performed.

FIG. 8A is an example calibration thermal image of a heater associated with a build platform of a three-dimensional printer with corners detected.

FIG. 8B is an example transformed representation of the calibration thermal image of FIG. 8A.

FIG. 9A is a side view of an example three-dimensional printer that uses a heater to calibrate formation of an article at a build platform.

FIG. 9B is a plan view of the build platform, its surrounding wall, and the heater of the example three-dimensional printer of FIG. 9A.

FIG. 10A is a plan view of an example heater having a discontinuous calibration pattern to calibrate formation of an article at a build platform of a three-dimensional printer.

FIG. 10B is a plan view of an example heater having a rounded calibration pattern to calibrate formation of an article at a build platform of a three-dimensional printer.

FIG. 100 is a plan view of an example heater having a three-cornered calibration pattern to calibrate formation of an article at a build platform of a three-dimensional printer.

### DETAILED DESCRIPTION

In additive manufacturing systems, such as thermal fusion three-dimensional printing systems, a camera may be used to monitor progress of a build and control operational parameters, as layers of material are progressively deposited and fused. The camera may be capable of capturing thermal images, as the material adding processes generate or dissipate heat, and captured thermal information of the build may be used to control operational parameters. This kind of feedback loop may increase the accuracy of the article being printed. For example, a thermal image may show that too much heat is present at one portion of an article being printed. As such, a cooling time may be lengthened to reduce a risk of thermal warpage and increase dimensional accuracy of the final article.

The images captured by such a camera are to be calibrated due to uncertainties in camera positioning and aim (e.g., due to manufacturing tolerances or if the camera is replaced) or image distortion due to a camera lens, so that the feedback imagery provided by the camera may be accurately mapped to the actual structure of the build. As such, a particular location in the image and its thermal information may be accurately mapped to a particular location at the build, so that the next pass of material addition at or near that location of the build may be adjusted.

The camera may capture thermal images of material fused into a predetermined calibration pattern that is separate from the build to calibrate for uncertainties in camera positioning and aim. However, this consumes material and time.

A heater of predetermined geometry is located near the build platform. The heater is turned on and the camera captures a thermal image of the heater for calibration purposes. The heater may extend around a perimeter of the build platform. Image recognition techniques may be used to resolve the image of the heater, even if a portion of the heater is located outside the camera's field of view. As such, the camera may be calibrated without fusing material.

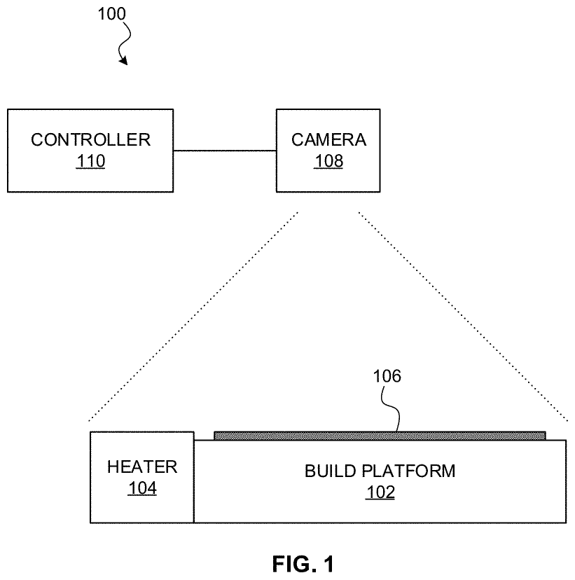

FIG. 1 shows an example device 100 to calibrate the formation of an article at a build platform 102 of a three-dimensional printer, or similar device, with reference to a heater 104 located near the build platform 102. The build platform 102 receives material 106 to be additively formed into an article. Examples of material 106 include polymer powder that may be progressively deposited in layers. The heater 104 is provided with a predetermined shape and is positioned at a predetermined location with respect to the build platform 102. The heater 104 may be a resistive heater, such as a resistive wire or thermal blanket, that heats up when voltage is applied.

The device 100 includes a camera 108 and a controller 110 connected to the camera 108.

The controller 110 may include a central processing unit (CPU), a microcontroller, a microprocessor, a processing core, a field-programmable gate array (FPGA), or a similar device capable of executing instructions. The controller 110 may cooperate with a non-transitory machine-readable medium that may be an electronic, magnetic, optical, or other physical storage device that encodes executable instructions. The machine-readable medium may include, for example, random access memory (RAM), read-only memory (ROM), electrically-erasable programmable read-only memory (EEPROM), flash memory, a storage drive, an optical disc, or similar.

The camera 108 is aimed towards the build platform 102 to capture thermal images of the build platform. The camera 108 may be a thermal or infrared camera, a camera capable of capturing visible and infrared light, or similar.

The thermal images captured by the camera 108 include a correction image that is captured during formation of an article at the build platform 102 and a calibration image that is used to calibrate the correction image. A correction image is referenced during formation of the article to adjust a parameter of the formation of the article. Any number of correction images may be captured during a build to facilitate any number of parameter adjustments. For example, a correction image may show too much or too little heat at a location of the article and the build process may be adjusted to provide less or more heat, respectively, at that location.

The controller 110 references a calibration image to compute a calibration for a correction image. The calibration is to compensate for uncertainty or inaccuracy in the position and aiming direction of the camera 108, image distortion caused by a camera lens, or similar. The calibration image may be captured at the start of a build, for example, prior to any material being fused.

The heater 104 is powered on when the calibration image is to be captured by the camera 108. The heater 104 has a predetermined shape, which may be termed a calibration pattern. As such, the controller 110 uses a representation of the heater 104 in the calibration image to perform the calibration.

The controller 110 may compute a transformation of a representation of the heater 104 in the calibration image. The transformation maps the representation of the heater 104 in the calibration image to a predetermined representation for an ideal camera position and aiming direction. The same camera 108 is used to capture correction images during build progress. Hence, the same transformation may be applied to captured correction images to correct for distorted apparent geometry resulting from non-ideal placement or aiming of the camera 108. As such, correction images may be compensated for the effects of non-ideal camera properties and used to print the article as expected.

An example computation of a transformation includes edge detection to identify lines within the calibration image that represent an example rectangular heater 104. A fitting function may also be performed to increase the accuracy in numerically modeling the heater 104. For an example rectangular heater, the resulting transformation may be defined by the four coordinates of the four corners of the heater 104 in the calibration image. If the heater 104 is shaped to surround the build platform 102 from the perspective of the camera 108, the four corner coordinates of the heater 104 denote the boundary of the printable area and may be applied to subsequent images captured by the camera 108 to map locations on such images to actual locations at the bed of material being printed.

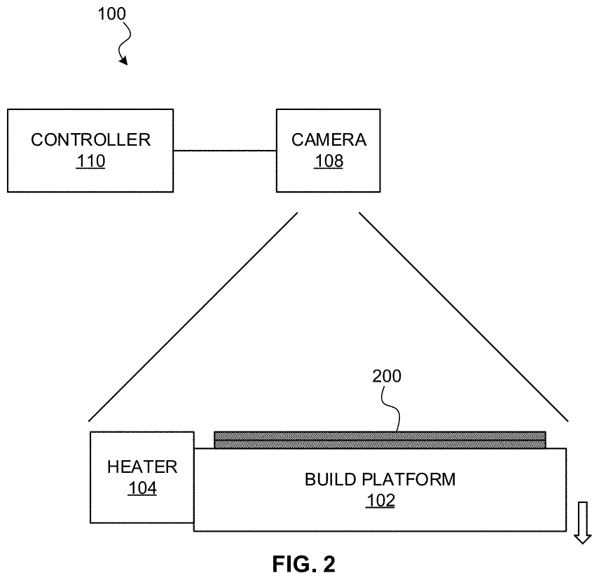

As shown in FIG. 2, as a build progresses, the build platform 102 is moved down and an additional layer of material 200 is provided on the build platform 102. The heater 104 may be fixed in positioned relative to the build platform 102 to be at the same location with respect to each layer of material 200. As the build progresses, the relative positions of the camera 108, heater 104, and current layer of material 200 remain fixed.

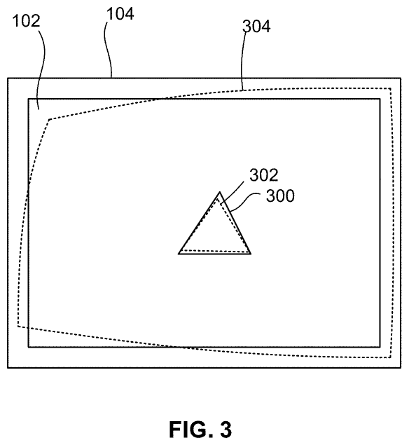

With reference to FIG. 3, an example heater 104 is shown surrounding a build platform 102, as viewed from above. The heater 104 may be rectangular in shape and thus have four corners. A partially completed article 300 is supported by the build platform 102. The heater 104, build platform 102, and article 300 are depicted in solid line to represent true shape and relative size.

An example representation 302 of the article 300, as captured by a camera 108 in an example thermal image, is distorted due to a camera characteristic such as position, aim, lens distortion, or similar cause. Such images may be captured as the article 300 is formed. However, thermal information in a representation 302 of the article 300 may not accurately correspond to the actual geometry of the article 300 and the accuracy of the material addition process could be reduced.

An example representation 304 of the heater 104, as captured in an example calibration thermal image, is likewise distorted due to the same camera characteristic. However, since the true shape and size of the heater 104 is known, the representation 304 of the heater 104 may be used to transform a thermal image of the representation 302 of the article 300 to calibrate the thermal image of the representation 302 of the article 300 for the camera characteristic.

A thermal image of a representation 304 of the heater 104 when turned on may be captured prior to starting a build. A transformation may be computed from the captured representation 304 of the heater 104. The heater 104 may then be turned off, the build started, and thermal images containing representations 302 of the article 300 may be calibrated using the transformation. In other examples, the heater 104 may be turned on and a representation 304 of the heater 104 may be captured at other times.

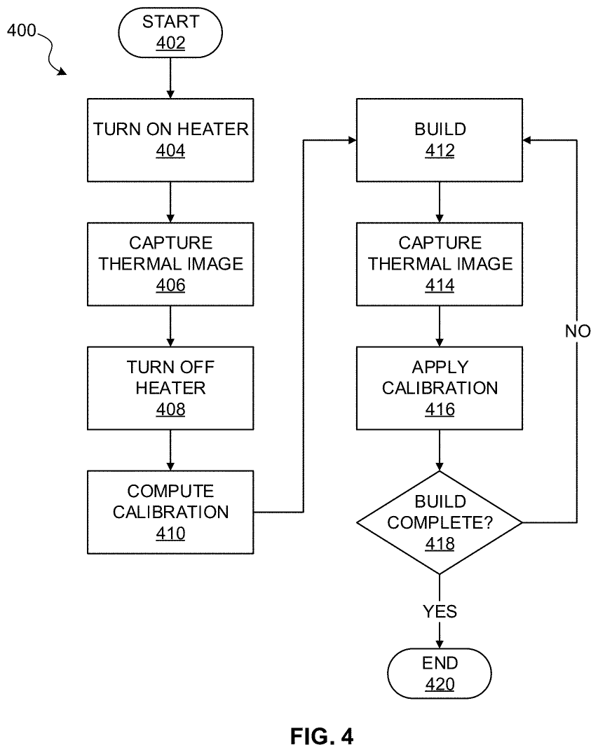

FIG. 4 shows an example method 400. The method 400 may be performed by any of the devices described herein or by other devices. The method starts at block 402, at which a build is initiated at a three-dimensional printer or similar device.

At block 404, a heater proximate to a build platform, from the perspective of a camera capable of capturing thermal images, is turned on.

Then, at block 406, a thermal image is captured by the camera. The thermal image contains a representation of the heater and may be referred to as a calibration image. A delay may be provided between blocks 404 and 406 to provide time for the heater to sufficiently warm to be detectable in the calibration image.

The heater may then be turned off, at block 408, after the calibration image is captured.

At block 410 a calibration may be computed based on the calibration image. The calibration is to account for distortion of captured images due to the camera. The calibration may be computed with reference to a predetermined shape of the heater and a representation of such shape in the calibration image.

The build commences, at block 412. During the build process, a thermal image, or correction image, may be used to adjust a parameter of the formation of the article, such as an amount of a chemical agent to apply, an amount of energy to apply, an amount of heat to apply, an amount of laser light to apply, a cooling duration, or similar. A parameter may be specific to a volumetric unit of the article and therefore may have accuracy dependent on the geometric fidelity of the correction image.

Further, during the build process, the camera may capture a correction image of the partially completed article, at block 414. At block 416, the calibration is applied to the correction image, so that parameter adjustments at block 412 are accurate with respect to the thermal state of the partially completed article. Applying the calibration may include applying a transformation, such as a spatial transformation based on corner coordinates of a rectangular heater, to distort the correction image so that the correction image more accurately represents the geometry of the article being built.

The build proceeds, via block 418, until complete. Any number of correction images may be captured and calibrated during a build. The method ends at block 420. The method 400 may be repeated for the next build, so that a change in a characteristic of the camera (e.g., the camera is accidentally moved) or failure of the camera may be determined prior to beginning the build. This may allow for the camera to be adjusted or replaced without having to clear build material from the system.

Regarding formation of a build, according to one example, a suitable fusing agent may be an ink-type formulation comprising carbon black, such as, for example, the fusing agent formulation commercially known as V1Q60A “HP fusing agent” available from HP Inc. In one example, such a fusing agent may additionally comprise an infrared light absorber. In one example, such an ink may additionally comprise a near infrared light absorber. In one example, such a fusing agent may additionally comprise a visible light absorber. In one example, such an ink may additionally comprise a UV light absorber. Examples of inks comprising visible light enhancers are dye-based colored ink and pigment-based colored ink, such as inks commercially known as CE039A and CE042A available from HP Inc. According to one example, a suitable detailing agent may be a formulation commercially known as V1Q61A “HP detailing agent” available from HP Inc. According to one example, a suitable build material may be PA12 build material commercially known as V1R10A “HP PA12” available from HP Inc.

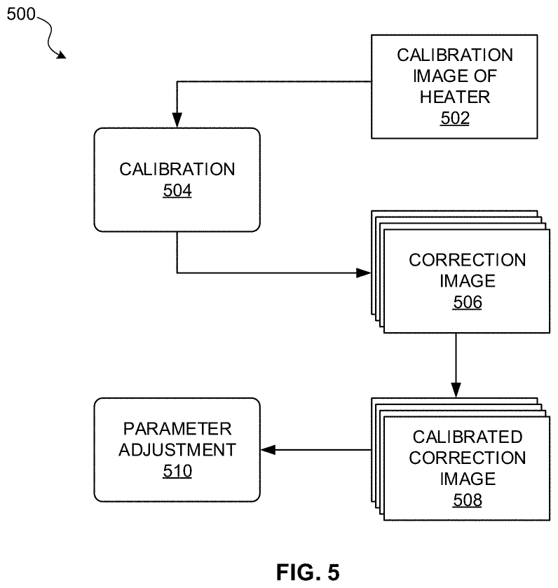

With reference to FIG. 5, an example workflow 500 uses a captured calibration thermal image 502 of a heater located at or near a build-material bed of a three-dimensional printer to perform a calibration 504. The calibration 504 is applied to a correction thermal image 506 that is captured during the build process. Applying the calibration 504 may include applying a distortion removal transformation to a correction thermal image 506. Such as transformation may use image coordinates of the corners of the heater in the calibration image. A resulting calibrated correction image 508 may then be used to adjust a parameter 510 of the three-dimensional printer during the build process. During a build, a plurality of correction thermal images 506 may be calibrated to obtain a plurality of calibrated correction image 508 using the same calibration 504.

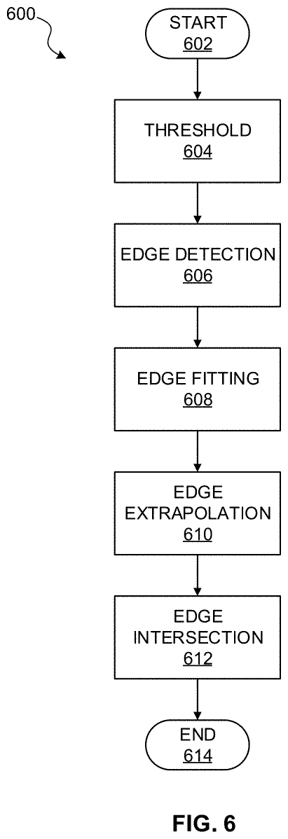

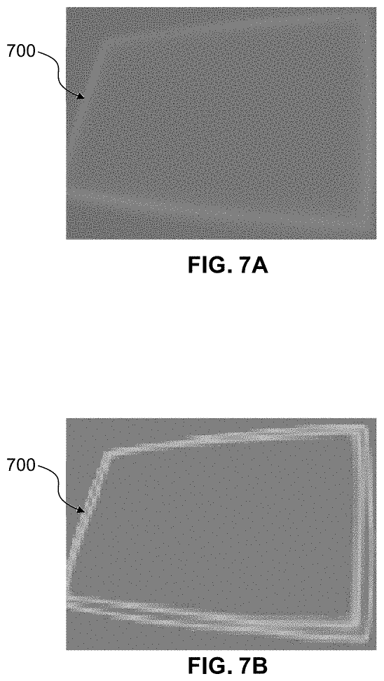

FIG. 6 shows a method 600 to compute a calibration based on a representation of a heater associated with a build platform. The method 600 is an example of block 410 of the method 400 of FIG. 4. The method 600 may be performed by any of the devices described herein or by other devices. The method starts at block 602, at which point a calibration thermal image that includes a heater has been captured. An example of a captured calibration thermal image is shown in FIG. 7A, in which the turned-on heater 700 appears lighter than other objects. An example rectangular heater may appear as a distorted rectangle due to relative position and angle between the camera and the print area. In addition, a degree of barreling (i.e., edge lines are not straight but slightly curved outside the center of the image) or other distortion may be caused by the camera lens.

At block 604, a threshold or similar image segmentation function may be applied to the thermal image to increase clarity of the representation of the heater with respect to other objects in the thermal image, such as a build platform. Example thresholding is shown in FIG. 7B.

At block 606, edge detection may be performed to identify an edge of the representation of the heater in the thermal image. In the example of a heater having shaped in a rectangular calibration pattern, four complete or partial edges 702, 704, 706, 708 may be detectable, as shown in FIG. 7C. Edge detection may include classification performed based on the pixel zone position. Detecting edges instead of corners is robust in case a corner is absent from the image.

At block 608, edge fitting may be performed to numerically model the detected edges. An edge fitting function, such as a quadratic function, may be found for each edge. An example edge fitting function 710 of a heater edge 708 is identified in FIG. 7D.

At block 610, edge extrapolation may be performed using the edge fitting function for an edge. Edges may be extrapolated to a predetermined bound or other limit to account for the absence of a corner of the heater in the calibration image. That is, the camera may be aimed such that a corner of heater may lie outside the captured calibration image.

At block 612, a corner of the representation of heater in the calibration image may be identified. For example, the extrapolated fitting functions of the heater edges may be numerically solved to fit the corners of the heater to obtain image coordinates of the corners of the heater. A corner may be represented by a X-Y pixel coordinate. The method ends at block 614.

The image coordinates of the corners of the heater may be used to define a transformation that is used to calibrate subsequently captured correction thermal images of an article being printed. As such, captured correction thermal images may be transformed into undistorted and position corrected images.

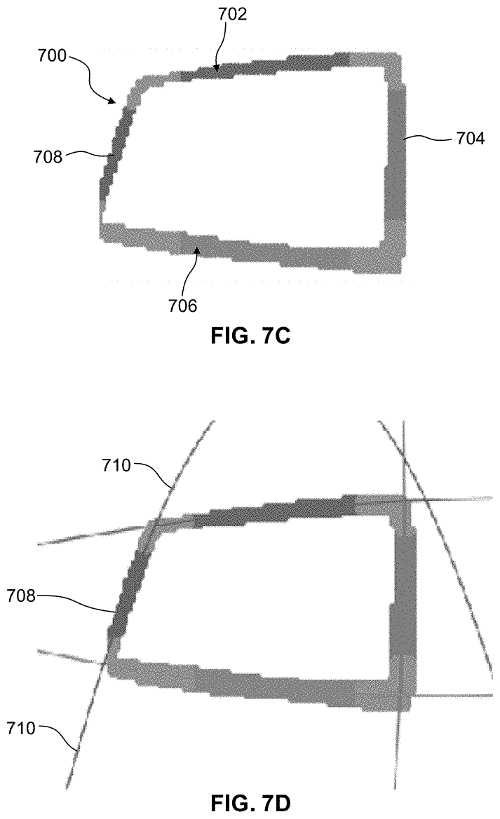

FIG. 8A shows an example calibration thermal image of a heater 700 with corners detected using the techniques described herein. In this example, a heater corner 800 is detected as located outside the calibration thermal image. Examples of image coordinates are also shown with respect to an image origin. FIG. 8B shows an example undistorted and position-corrected image resulting from the corner coordinates being used to transform the calibration thermal image of FIG. 8A. As can be seen, the representation of the heater 700 is transformed to be closer to its actual shape, which in this example is a rectangle as viewed from the perspective of the camera. Any printing material in the print area captured in such an image would be correspondingly transformed. In actual operations, the heater would be turned off when images like the image of FIG. 8B are captured and so the heater would not appear in such images.

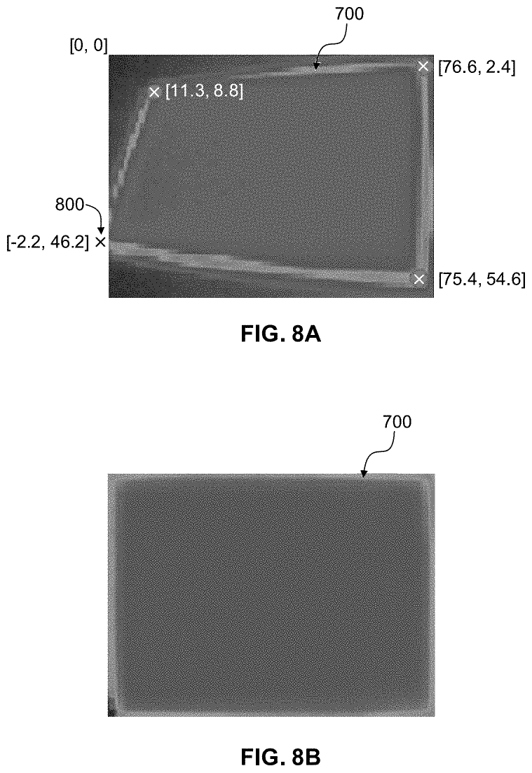

FIGS. 9A and 9B show an example three-dimensional printer 900. The printer 900 may be similar to the other devices described herein and may incorporate features and aspects of such devices. Like reference numerals denote like components and redundant description is omitted for sake of clarity. The printer 900 may perform any of the methods described herein.

The printer 900 includes a build platform 902, a wall 904 that surrounds the build platform 902, a printhead 906 moveably positioned above the build platform 902, a scraper 908 moveably positioned above the build platform 902, a camera 108, a controller 110, and a heater 910 proximate to the build platform 902.

The controller 110 may control operations of the build platform 902, scraper 908, printhead 906, camera 108, and heater 910.

During the formation of an article 912, the build platform 902 is moved downwards and material 914, such as a layer of fusible powder, is spread onto the build platform 102 (if the first layer) or onto material already present on the build platform 102, such as unfused material 916 and fused material of the article 912. The scraper 908 may be moved across material coarsely spread by a material delivery mechanism (not shown) to form a thin layer of material 914 that may be fused to form part of the article 912.

The printhead 906 may include an array of droplet ejectors, such as the kinds used in thermal inkjet printing. The printhead 906 may be moved across a freshly deposited thin layer of material 914 and may jet a chemical fusing agent, binding agent, curing agent, or combination onto the material 914. The printhead 906 may also apply energy to the material 914. The printhead 906 therefore selectively fuses the material 914 into a portion of the article 912.

As the scraper 908 and printhead 906 move back and forth to distributed and to fuse progressively added layers of material 914, the build platform 902 is moved downwards within the surrounding wall 904 to contain fused material of the article 912 and unfused material 916 within an available volume which may be termed a print bucket 918. When the build is complete, the print bucket contains the article 912 as well as unfused material 916 that may be recovered and recycled.

The camera 108 is capable of capturing thermal information within its field of view 920. The camera 108 may be aimed towards a location at the printer 900 that receives the print bucket 918. Components that define the print bucket 918, such as the wall 904 and the build platform 902, may be removable from the printer 900. In some examples, components that define the print bucket 918 are removable from the printer 900 as a unit that may be used, stored, or transported separately from the printer 900. The depicted arrangement shows the print bucket 918 installed at its location in the printer 900. This location at the printer 900 may include a receiving bay to receive the print bucket 918.

During the build process, the camera 108 may be controlled to capture thermal images of the current layer of material 914 of the article 912. The controller 110 may use such correction images to adjust or tune operational parameters of the printhead 906, such as a speed of motion, an amount of an agent to eject at a particular location on a layer of material 914 or on a subsequent layer, an amount of energy to apply to a particular location of a layer of material 914 or a subsequent layer, or similar.

The heater 910 may include a resistive wire, thermal blanket, or similar. The heater 910 may be disposed on an inner or outer surface of the wall 904 that surrounds the build platform 902. The heater 910 may be embedded in the wall 904. The heater 910 may be positioned at a location that remains fixed with respect to the print area, i.e., the current layer of material 914, as printing progresses. That is, the heater 910 may be at a fixed location on the print bucket 918, where such location does not change as the build platform 902 moves to change the size of the print bucket 918.

The heater 910 is shaped as a calibration pattern, such as a rectangle that surrounds the build platform 902 and material 914 thereon, as shown in FIG. 9B, which takes the perspective of an ideal camera. The heater 910 may thus be positioned to delineate a perimeter of the print bucket 918 in thermal images captured by the camera 108. The calibration pattern defined by the heater 910 is to be captured in a calibration thermal image by the camera 108.

The controller 110 uses the calibration thermal image containing the heater to calibrate correction images captured during the build process against uncertain placement or angle of the camera 108, camera 108 lens distortion in captured images, or a similar camera 108 characteristic, as described elsewhere herein.

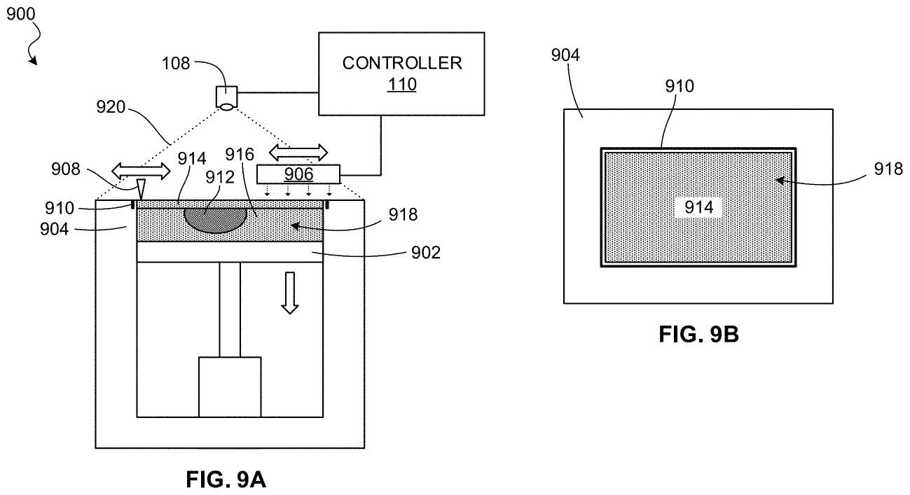

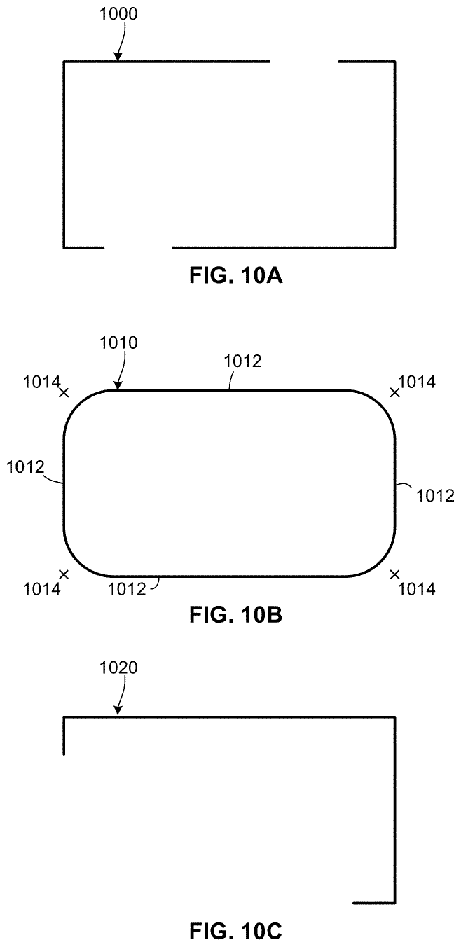

FIGS. 10A to 10D show other example calibration patterns for heaters

FIG. 10A shows a heater 1000 having a discontinuous calibration pattern. Separate segments of the heater may be electrically connected by wires that do not emit heat in an amount that may be captured by a camera.

FIG. 10B shows a heater 1010 having a rounded calibration pattern. For example, when edge detection is used to identify lengths 1012 of the heater 1010 and when such lengths are extrapolated, as discussed elsewhere herein, the corner coordinates 1014 used by the calibration need not be physically present on the heater 1010, provided that the coordinates 1014 are derivable from the shape of the heater 1010.

FIG. 10A shows a heater 1020 having a three-cornered calibration pattern.

As described above, a heater, such as a thermal blanket, may be used to identify a perimeter of a print bucket of a three-dimensional printer using a thermal camera. The representation of the heater may be used to align subsequently captured images, such as print parameter correction images, to the print area. Corner position of the print bucket may be identified even when located out of the image. The thermal camera may be calibrated prior to print bed formation and thus without having to use printing material, which may save time, material, and clean up, and further may allow for an increase in the useable vertical range of a print platform. Calibration may be performed even when a material fusing apparatus is not working.

It should be recognized that features and aspects of the various examples provided above can be combined into further examples that also fall within the scope of the present disclosure. In addition, the figures are not to scale and may have size and shape exaggerated for illustrative purposes.

1. A device comprising:
a camera to aim towards a build platform to receive material to be fused to form an article, the camera to capture thermal images including a correction image captured during formation of the article at the build platform, the correction image to be referenced to adjust a parameter of the formation of the article at the build platform; and
a controller connected to the camera, the controller to control the camera to capture a calibration image with a heater associated with the build platform turned on, the controller further to use the calibration image to compute a calibration to apply to the correction image.

2. The device of claim 1, wherein the controller is to detect a representation of a corner of the heater in the calibration image and the calibration references a representation of the corner in the calibration image.

3. The device of claim 2, wherein the controller is to detect edges in the calibration image as representations of lengths of the heater and is further to extrapolate the edges to determine a location of the corner of the heater.

4. The device of claim 1, wherein the controller is to compute the calibration for the correction image by computing a transformation of a representation of the heater in the calibration image, the transformation mapping the representation of the heater in the calibration image to a predetermined representation.

5. The device of claim 4, wherein the predetermined representation is rectangular.

6. A device comprising:
a build platform to receive material to be fused to form an article; and
a heater disposed proximate to the build platform, the heater shaped as a calibration pattern to be captured in a calibration thermal image by a camera used to capture a correction thermal image of the article during formation of the article at the build platform.

7. The device of claim 6, wherein the heater surrounds the build platform from a perspective of the camera.

8. The device of claim 6, wherein the heater is disposed at a wall that surrounds the build platform.

9. The device of claim 6, wherein the calibration pattern comprises a corner.

10. The device of claim 6, wherein the calibration pattern comprises a rectangle.

11. A printer comprising:
a printhead to eject an agent;
a camera aimed towards a location to receive a print bucket, the camera to capture thermal images of the print bucket, the print bucket including a moveable build platform to support a material to receive the agent from the printhead to form an article, a heater at the print bucket shaped in a calibration pattern; and
a controller to connect to the printhead, the heater, and the camera, the controller to apply a calibration to captured thermal images of the material in the print bucket based on a thermal image captured with the heater turned on.

12. The printer of claim 11, wherein the heater surrounds the moveable build platform from a perspective of the camera.

13. The printer of claim 11, wherein the calibration pattern is rectangular.

14. The printer of claim 11, wherein the controller is to apply the calibration by transforming a captured thermal image of the material in the print bucket based on coordinates of corners of the heater.

15. The printer of claim 14, wherein the controller is to extrapolate an edge of a representation of the heater in the thermal image captured with the heater turned on to identify a corner of the heater that is not represented in the thermal image.
